(19) United States
(12) Patent Application Publication
(10) Pub. No.: US 2026/0259542 A1
(43) Pub. Date: Sep. 3, 2026

(54) NUMERICAL VALUE CONTROL DEVICE AND A NON-TRANSITORY COMPUTER-READABLE STORAGE MEDIUM

(71) Applicant: FANUC CORPORATION, Yamanashi (JP)

(72) Inventor: Daiki KIKKAWA, Yamanashi (JP)

(73) Assignee: FANUC CORPORATION, Yamanashi (JP)

(21) Appl. No.: 18/878,324

(22) PCT Filed: Jul. 27, 2022
(86) PCT No.: PCT/JP2022/028998

§ 371 Date: Dec. 23, 2024

(51) Int. Cl. G05B 19/402

(52) U.S. Cl. CPC G05B 19/402; G05B 2219/36199; G05B 2219/42249

(57) ABSTRACT

To make it possible to compensate for a gap amount and also compensate for a laser radiation position on a machining target surface. A numerical control device controls a machine tool. The machine tool performs relative movement of a machining nozzle 72 and a workpiece 82, and radiates a laser beam toward a machining surface S of the workpiece 82 from the machining nozzle 72, thereby performing laser machining on the machining surface S. The numerical control device acquires a gap amount G as the shortest distance from the machining nozzle 72 to the machining target surface S. The numerical control device calculates a normal direction sZ of the machining surface S and calculates a normal-direction movement amount V for causing the machining nozzle 72 and the workpiece 82 to relatively move in the normal direction sZ to set the gap amount G to a desired gap amount Go. The numerical control device compensates for the gap amount G to the desired gap amount Go by causing the machining nozzle 72 and the workpiece 82 to relatively move in the normal direction sZ based on the calculated normal-direction movement amount V.

### TECHNICAL FIELD

The present disclosure relates to a numerical control device for controlling a machine tool.

### BACKGROUND ART

Among machine tools, there are some that perform relative movement of a machining nozzle and a workpiece and radiate a laser beam toward the machining surface of the workpiece from the machining nozzle, thereby performing laser machining on the machining surface.

Among numerical control devices for controlling such machine tools, there are some that detect a “gap amount” as the shortest distance from the machining nozzle to the machining surface and compensate for the gap amount to a desired gap amount by feedback control or the like based on the detected gap amount.

### CITATION LIST

### Patent Document

Patent Document 1: Japanese Unexamined Patent Application, Publication No. 2017-111661

### DISCLOSURE OF THE INVENTION

### Problems to be Solved by the Invention

The inventors focused on the point that a problem shown below may occur. Hereinafter, a two-dimensional direction along a machining surface will be referred to as a “machining surface direction”; a direction orthogonal to the machining surface will be referred to as a “normal direction”; and a direction of laser radiation by a machining nozzle will be referred to as a “radiation direction”.

In laser machining, there may be a case where a laser beam is radiated, with the radiation direction inclined relative to the normal direction, for example, like the case of edge preparation of forming a V-shaped groove in cross section. In this case, a workpiece and a machining nozzle may deviate from desired relative positions, and a gap amount may deviate from a desired gap amount. If the relative positions of the workpiece and the machining nozzle are controlled in the machining surface direction in the above state, the relative positions of the machining nozzle and the workpiece deviate from the desired relative positions in the normal direction. Then, since the radiation direction is inclined relative to the normal direction, a laser radiation position on the machining surface also deviates from a desired radiation position due to the deviation in the normal direction.

Even if the gap amount is compensated by relatively moving the machining nozzle and the workpiece in the radiation direction from the above state, only the gap amount is compensated to the desired gap amount, but the laser radiation position on the machining surface is kept in a deviated position and is not compensated to the desired radiation position because the direction of the relative movement is the radiation direction.

The present disclosure has been made in view of the above situation, and an object thereof is to make it possible to perform compensation of a laser radiation position on a machining surface as well as compensation of a gap amount.

### Means for Solving the Problems

A numerical control device of the present disclosure is a numerical control device for controlling a machine tool, the machine tool performing relative movement of a machining nozzle and a workpiece, and radiating a laser beam toward a machining surface of the workpiece from the machining nozzle, thereby performing laser machining on the machining surface, the numerical control device including:
a gap amount acquisition unit acquiring a gap amount as a shortest distance from the machining nozzle to the machining surface;
a normal calculation unit calculating a normal direction of the machining surface;
a movement amount calculation unit calculating a normal-direction movement amount as a movement amount for setting the gap amount to a desired gap amount by causing the machining nozzle and the workpiece to relatively move in the calculated normal direction; and
a gap compensation unit compensating for the gap amount to the desired gap amount by causing the machining nozzle and the workpiece to relatively move in the normal direction based on the calculated normal-direction movement amount.

According to the numerical control device of the present disclosure, it is possible to, by causing the machining nozzle and the workpiece to relatively move not in the laser radiation direction but in the normal direction of the machining surface at the time of compensating for the gap amount, perform compensation of the laser radiation position on the machining surface as well as compensation of the gap amount.

A numerical control program of the present disclosure is a numerical control program for causing a computer to function as:
a numerical control device for controlling a machine tool, the machine tool performing relative movement of a machining nozzle and a workpiece, and radiating a laser beam toward a machining surface of the workpiece from the machining nozzle, thereby performing laser machining on the machining surface, the numerical control program further causing the computer to function as:
a gap amount acquisition unit acquiring a gap amount as a shortest distance from the machining nozzle to the machining surface;
a normal calculation unit calculating a normal direction of the machining surface;
a movement amount calculation unit calculating a normal-direction movement amount as a movement amount for setting the gap amount to a desired gap amount by causing the machining nozzle and the workpiece to relatively move in the calculated normal direction; and
a gap compensation unit compensating for the gap amount to the desired gap amount by causing the machining nozzle and the workpiece to relatively move in the normal direction based on the calculated normal-direction movement amount.

According to the numerical control program of the present disclosure, it is possible to cause a computer to function as the numerical control device of the present disclosure. Thereby, similarly to the case of the numerical control device of the present disclosure, it is possible to perform compensation of the laser radiation position on the machining surface as well as compensation of the gap amount.

### BRIEF DESCRIPTION OF THE DRAWINGS

FIG. 1 is a schematic diagram showing a numerical control device of a first embodiment;

FIG. 2 is a side view showing a situation in which a laser beam is radiated obliquely relative to a machining surface;

FIG. 3 is a side view showing a case where a workpiece has deviated in a normal direction in the situation of FIG. 2.

FIG. 4 is a side view showing gap compensation in a comparison example;

FIG. 5 is a side view showing gap compensation in the present embodiment;

FIG. 6 is a schematic diagram showing the numerical control device from a viewpoint different from that of FIG. 1;

FIG. 7 is a schematic diagram showing a numerical control device of a second embodiment;

FIG. 8 is a side view showing a state in which a first machining surface is selected as a current machining surface; and

FIG. 9 is a side view showing a state in which a second machining surface is selected as the current machining surface.

### PREFERRED MODE FOR CARRYING OUT THE INVENTION

Embodiments of the present disclosure will be described below with reference to drawings. The present disclosure, however, is not limited to the embodiments below and can be implemented with appropriate changes within a range not departing from the spirit of the present disclosure.

### First Embodiment

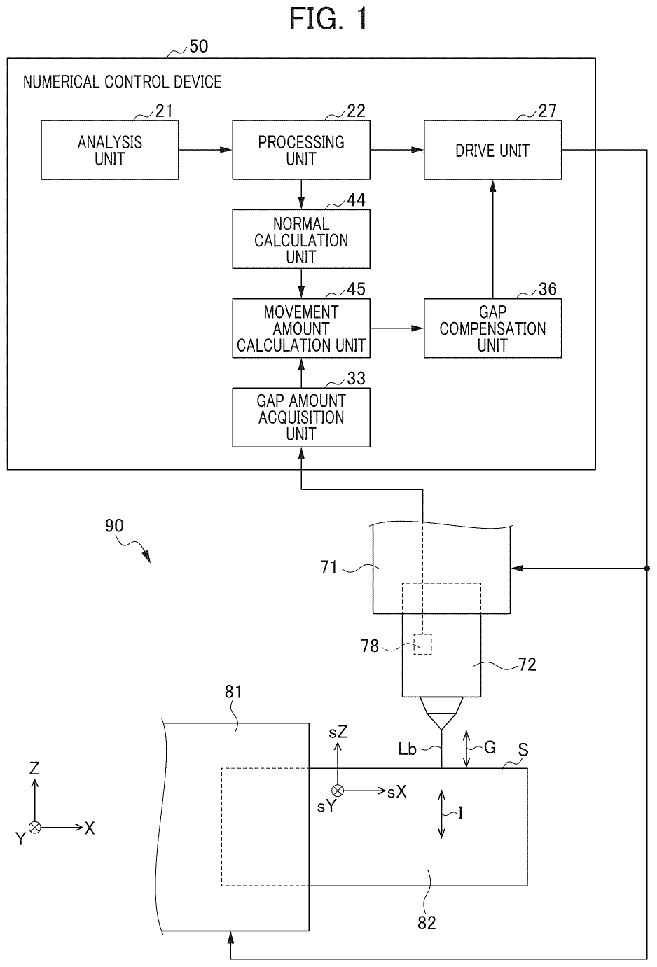

First, a configuration of a numerical control device 50 of the present embodiment will be described with reference to FIG. 1. The numerical control device 50 controls a machine tool 90 by a command with numerical information. Hereinafter, three directions mutually intersecting at right angles will be referred to as an “X direction”, a “Y direction”, and a “Z direction”. Specifically, for example, the X direction and the Y direction are two directions mutually intersecting at right angles within a horizontal plane, and the Z direction is a vertical direction.

The machine tool 90 includes a nozzle holding unit 71 that holds a machining nozzle 72, and a workpiece holding unit 81 that holds a workpiece 82. The machine tool 90 causes the machining nozzle 72 and the workpiece 82 to move relative to each other by causing the nozzle holding unit 71 and the workpiece holding unit 81 to move relative to each other. Specifically, the relative movement includes all or a part of relative movement in the X direction, relative movement in the Y direction, relative movement in the Z direction, relative movement around the X direction, relative movement around the Y direction, and relative movement around the Z direction. Each of the relative movements may be performed by causing the machining nozzle 72 to move, by causing the workpiece 82 to move, or causing both of the machining nozzle 72 and the workpiece 82 to move.

The machine tool 90 performs laser machining by radiating a laser beam Lb to the workpiece 82 from the machining nozzle 72. Hereinafter, a direction in which the laser beam Lb is radiated by the machining nozzle 72 will be referred to as a “radiation direction I”. Further, hereinafter, a surface of the workpiece 82 where the laser beam Lb is radiated will be referred to as a “machining surface S”; a two-dimensional direction along the machining surface S will be referred to as a “machining surface direction sX, sY”; and a normal direction of the machining surface S will be referred to as a “normal line sz”. Further, hereinafter, the shortest distance between the tip part of the machining nozzle 72 and the machining surface S, that is, a distance therebetween in the normal line sz will be referred to as a “gap amount G”.

The machining nozzle 72 includes a gap amount detection device 78 for detecting the gap amount G. The gap amount detection device 78 detects the gap amount G, for example, based on capacitance between the tip of the machining nozzle 72 and the workpiece 82.

The numerical control device 50 is configured such that a machining program can be inputted by a user or the like, and controls the machine tool 90 based on the inputted machining program. The numerical control device 50 includes an analysis unit 21, a processing unit 22, and a drive unit 27. The analysis unit 21 analyzes the inputted machining program. The processing unit 22 calculates an amount of movement of the nozzle holding unit 71 and the workpiece holding unit 81 for causing the machining nozzle 72 and the workpiece 82 to be at desired relative positions, based on a result of the analysis by the analysis unit 21. The drive unit 27 outputs an operation command to the machine tool 90 based on a result of the calculation by the processing unit 22.

The numerical control device 50 further includes a gap amount acquisition unit 33 and a gap compensation unit 36. The gap amount acquisition unit 33 acquires the gap amount G detected by the gap amount detection device 78, from the gap amount detection device 78. Based on the gap amount G acquired by the gap amount acquisition unit 33, the gap compensation unit 36 compensates for the gap amount G to a desired gap amount Go by performing feedback control or the like.

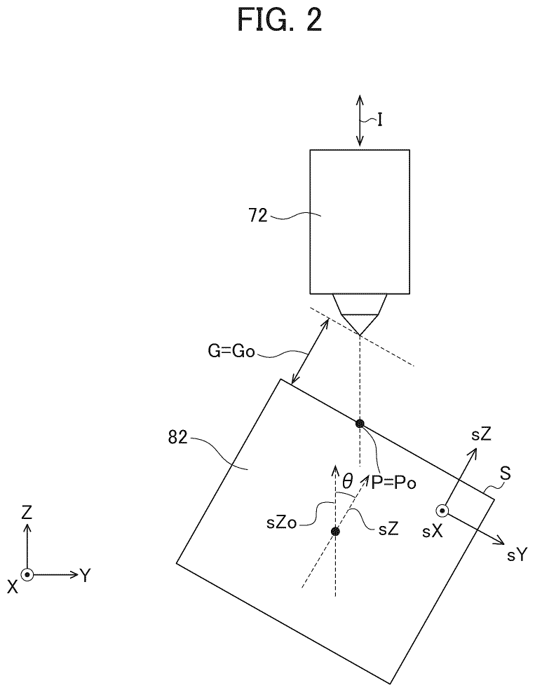

Next, a problem to be solved in the present embodiment will be described with reference to FIGS. 2 to 4.

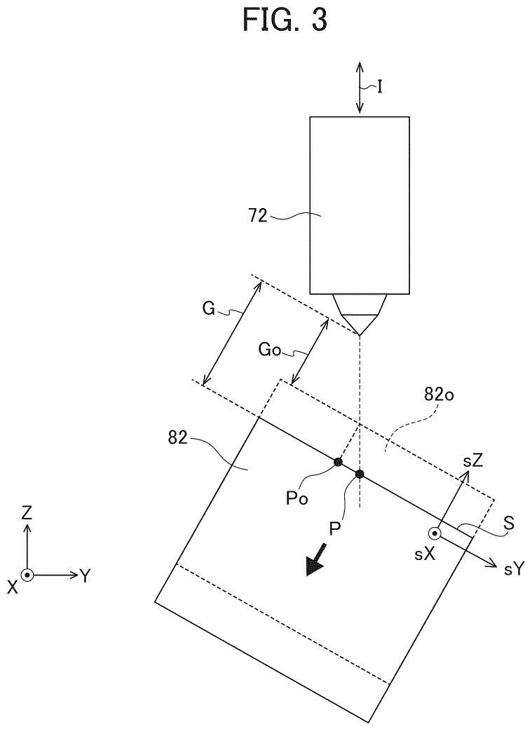

As shown in FIG. 2, in laser machining, there may be a case where a laser beam is radiated, with the radiation direction I inclined relative to the normal direction sZ, for example, like the case of edge preparation of forming a V-shaped groove in cross section. In this case, the workpiece 82 and the machining nozzle 72 may deviate from desired relative positions, and the gap amount G may deviate from the desired gap amount Go. When the relative positions of the workpiece 82 and the machining nozzle 72 are controlled in the machining surface direction sX, sY in the above state, the relative position of the workpiece 82 relative to the machining nozzle 72 deviates from a desired position 820 denoted by a broken line in FIG. 3 to a position (82) denoted by a solid line in FIG. 3. In other words, the relative positions of the machining nozzle 72 and the workpiece 82 deviate from the desired relative positions in the normal direction sZ. Then, since the radiation direction I is inclined relative to the normal direction sZ, a laser radiation position P on the machining surface S also deviates from a desired radiation position Po due to the deviation of the relative positions in the normal direction sZ.

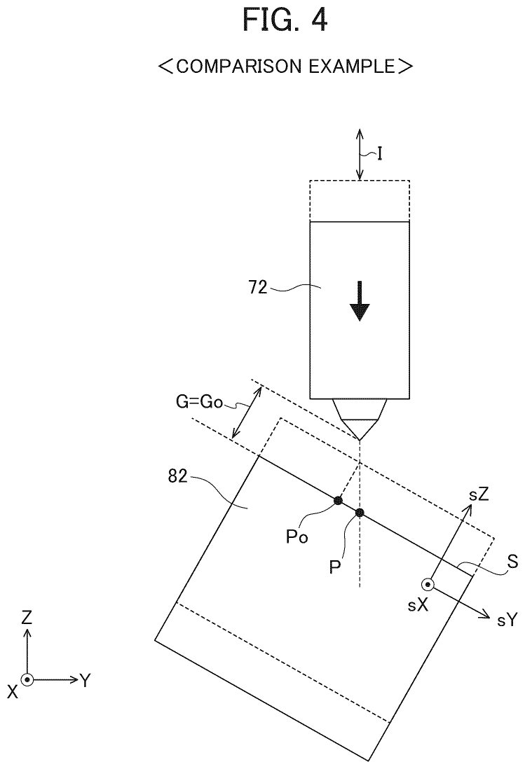

It is assumed that, from the above state, the machining nozzle 72 and the workpiece 82 are relatively moved in the radiation direction I to compensate for the gap amount G, for example, like a comparison example shown in FIG. 4. In this case, only the gap amount G is compensated to the desired gap amount Go, but the radiation position P on the machining surface S is kept in the deviated position and is not compensated to the desired radiation position Po because the direction of the relative movement is the radiation direction I.

In order to solve the above problem, the numerical control device 50 further includes a normal calculation unit 44 and a movement amount calculation unit 45 as shown in FIG. 1. The normal calculation unit 44 recognizes a rotation angle θ from a predetermined reference state for the workpiece 82 to calculate the normal direction sZ, based on the machining program.

Specifically, as shown in FIG. 2, the normal calculation unit 44 calculates the normal direction sZ based on a reference normal direction sZo as the normal direction sZ at the time when the workpiece 82 is in the reference state and the rotation angle θ from the reference state of the workpiece 82 based on the machining program. In other words, the reference normal direction sZo rotated by the rotation angle θ is the normal direction sZ.

More specifically, for example, it is assumed that the workpiece 82 is rotated around the X direction when the Z direction is the reference normal direction sZo, like FIG. 2. A unit vector (Xu, Yu, Zu), that is, a vector the absolute value of which is “1” in the normal direction sZ in this case can be represented by Formula 1 below. The normal calculation unit 44 obtains the normal direction sZ by calculating the unit vector (Xu, Yu, Zu).

$$[ \begin{matrix}Xu \\ Yu \\ Zu\end{matrix} ] = [ \begin{matrix}1 & 0 & 0 \\ 0 & cosθ & - sinθ \\ 0 & sinθ & cosθ\end{matrix} ] [ \begin{matrix}0 \\ 0 \\ 1\end{matrix} ] = [ \begin{matrix}0 \\ - sinθ \\ cosθ\end{matrix} ] \qquad [ Formula 1 ]$$

The movement amount calculation unit 45 calculates a “normal-direction movement amount V” as a relative movement amount of the machining nozzle 72 and the workpiece 82 in the normal direction sZ, for compensating for the gap amount G shown in FIG. 3 to the desired gap amount Go, Specifically, the normal-direction movement amount V can be determined, for example, from a difference between the gap amount G and the desired gap amount Go, and an angle of the radiation direction I relative to the normal direction sZ.

The gap compensation unit 36 calculates a normal-direction movement vector (Xv, Yv, Zv) by multiplying the unit vector (Xu, Yu, Zu)=(0, −sin θ, cos θ) represented by Formula 1 above by the normal-direction movement amount V, as shown in Formula 2 below.

$$[ \begin{matrix}Xv \\ Yv \\ Zv\end{matrix} ] = V \times [ \begin{matrix}0 \\ - sinθ \\ cosθ\end{matrix} ] \qquad [ Formula 2 ]$$

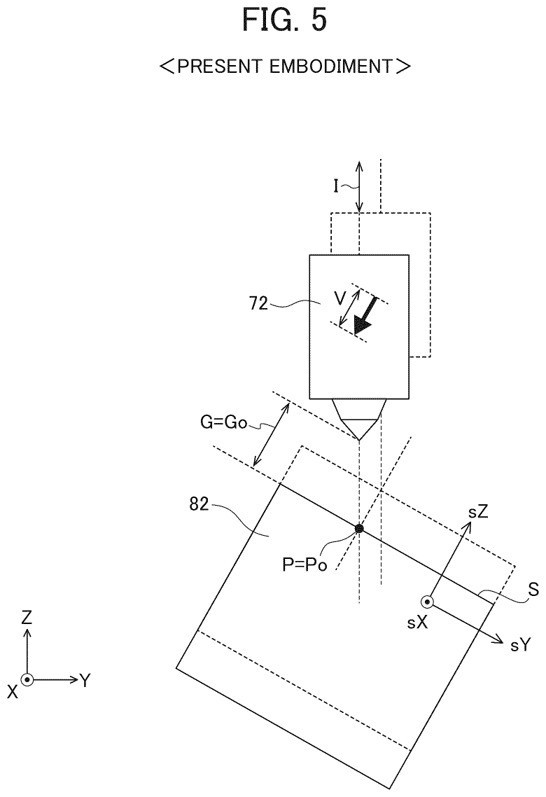

By working on the drive unit 27, the gap compensation unit 36 causes the machining nozzle 72 and the workpiece 82 to relatively move in the X direction, the Y direction, and the Z direction by amounts of components of the normal-direction movement vector (Xv, Yv, Zv), respectively. Thereby, the machining nozzle 72 and the workpiece 82 relatively move in the normal direction sZ by the normal-direction movement amount V as shown in FIG. 5. Thereby, the gap amount G is compensated to the desired gap amount Go, and the laser radiation position P on the machining surface S is also compensated to the desired radiation position Po.

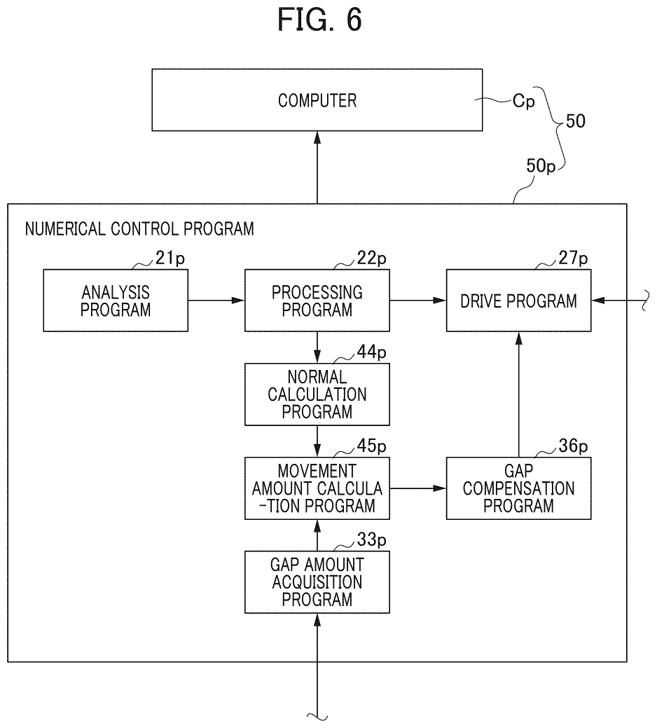

As shown in FIG. 6, the numerical control device 50 shown above is configured, for example, mainly with a computer Cp and a numerical control program 50p. The computer Cp includes a CPU, a RAM, a ROM, and the like. The numerical control program 50p is a program for causing the computer Cp to function as the numerical control device 50 in cooperation with the computer Cp. The numerical control program 50p includes an analysis program 21p, a processing program 22p, a drive program 27p, a normal calculation program 44p, a movement amount calculation program 45p, a gap amount acquisition program 33p, and a gap compensation program 36p.

The analysis program 21p causes the computer Cp to function as the analysis unit 21. The processing program 22p causes the computer Cp to function as the processing unit 22. The drive program 27p causes the computer Cp to function as the drive unit 27. The normal calculation program 44p causes the computer Cp to function as the normal calculation unit 44. The movement amount calculation program 45p causes the computer Cp to function as the movement amount calculation unit 45. The gap amount acquisition program 33p causes the computer Cp to function as the gap amount acquisition unit 33. The gap compensation program 36p causes the computer Cp to function as the gap compensation unit 36.

The configuration and effects of the present embodiment will be summarized below.

The normal calculation unit 44 calculates the normal direction sZ of the machining surface S. The movement amount calculation unit 45 calculates the “normal-direction movement amount V” for causing the machining nozzle 72 and the workpiece 82 to relatively move in the calculated normal direction sZ to compensate for the gap amount G to the desired gap amount Go. The gap compensation unit 36 compensates for the gap amount G to the desired gap amount Go by causing the machining nozzle 72 and the workpiece 82 to relatively move in the normal direction sZ by the calculated normal-direction movement amount V. Thus, it is possible to, by causing the machining nozzle 72 and the workpiece 82 to relatively move not in the radiation direction I but in the normal direction sz at the time of compensating for the gap amount G, compensate for not only the gap amount G but also the laser radiation position P on the machining surface S.

The normal calculation unit 44 calculates the normal direction sZ based on the reference normal direction sZo as the normal direction sZ at the time when the workpiece 82 is in the predetermined reference state and the rotation angle θ from the reference state of the workpiece 82 based on the machining program. Therefore, it is possible to simply and efficiently calculate the normal direction sZ.

The numerical control device 50 is configured mainly with the computer Cp and the numerical control program 50p, and the numerical control program 50p causes the computer Cp to function as the numerical control device 50, Therefore, it is possible to use the computer Cp to implement the numerical control device 50 of the present embodiment.

### Second Embodiment

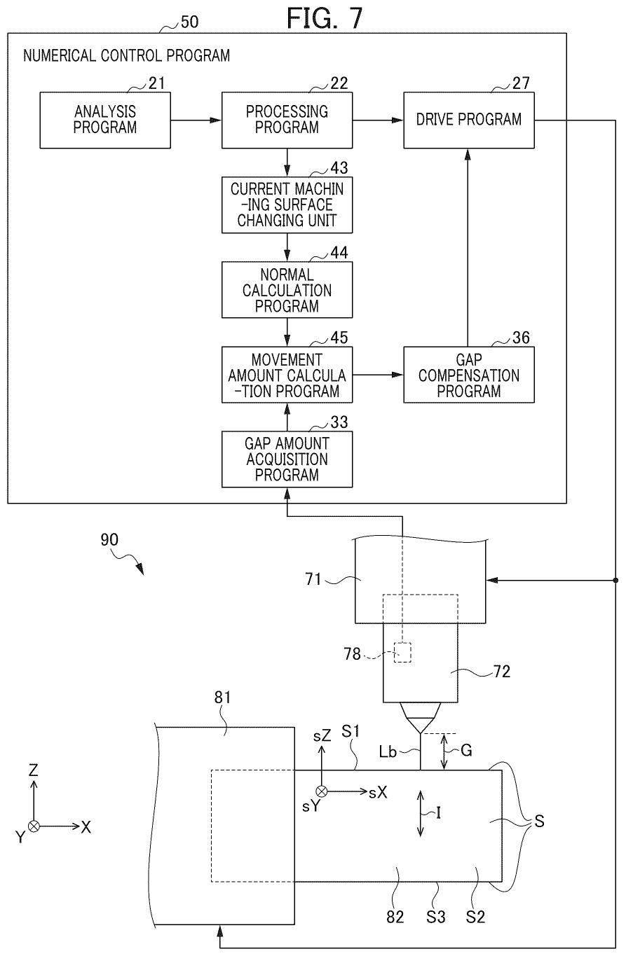

Next, a second embodiment will be described with reference to FIGS. 7 to 9. For the present embodiment, points different from the first embodiment will be mainly described based on the first embodiment, and description of points that are the same as or similar to the first embodiment will be appropriately omitted.

In the present embodiment, laser machining of a plurality of faces of the workpiece 82 is performed. Therefore, the workpiece 82 has a plurality of machining surfaces S as shown in FIG. 7. Therefore, the numerical control device 50 further includes a current machining surface changing unit 43. The current machining surface changing unit 43 selects one of the plurality of machining surfaces S as a current machining surface Sc based on the shape of the workpiece 82 set in advance and the rotation angle θ from the reference state of the workpiece 82.

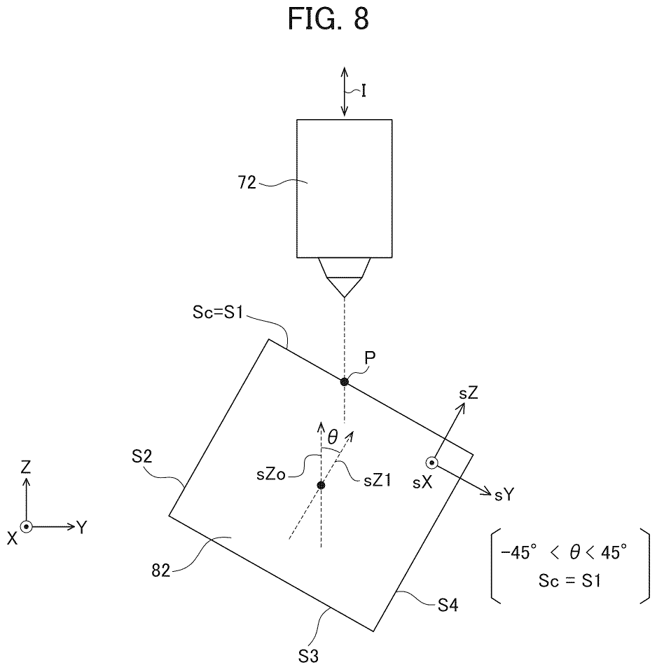

Specifically, for example, the workpiece 82 is in a square prism shape both end faces of which in the X direction side are rectangular. In other words, the workpiece 82 is rectangular when seen in the X direction as shown in FIG. 8. When seen in the X direction, the workpiece 82 has a first machining surface S1 as the machining surface S on one long side, a second machining surface S2 as the machining surface S on one short side, a third machining surface S3 as the machining surface S on the opposite side of the first machining surface S1, and a fourth machining surface S4 as the machining surface on the opposite side of the second machining surface S1.

More specifically, for example, it is also assumed here that the workpiece 82 is rotated around the X direction when the Z direction is the reference normal direction sZo similarly to the example shown in the first embodiment. Here, a state in which a “first normal direction sZ1”, which is the normal direction sZ of the first machining surface S1, is the reference normal direction sZo is assumed as the “reference state”, and an angle of the first normal direction sZ1 relative to the reference normal direction sZo is assumed as the “rotation angle θ of the workpiece 82”.

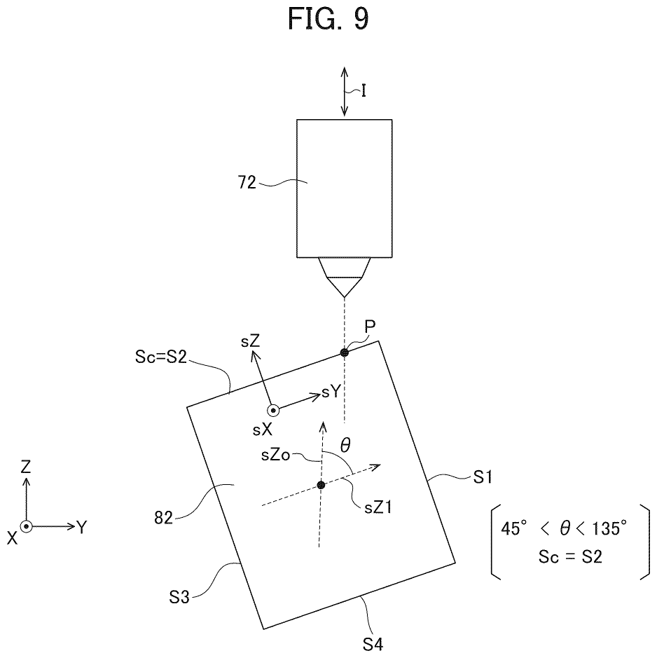

As shown in FIG. 8, if the rotation angle θ of the workpiece 82 is between −45° and 45°, the current machining surface changing unit 43 selects the first machining surface S1 as the current machining surface Sc. On the other hand, as shown in FIG. 9, if the rotation angle θ of the workpiece 82 is between 45° and 135°, the second machining surface S2 is selected as the current machining surface Sc. Further, if the rotation angle θ of the workpiece 82 is between 135° and 225°, the third machining surface S3 is selected as the current machining surface Sc. Further, if the rotation angle θ of the workpiece 82 is between 225° and 315′, the fourth machining surface S4 is selected as the current machining surface Sc.

The normal calculation unit 44 shown in FIG. 7 calculates the normal direction sZ of the selected current machining surface Sc. The movement amount calculation unit 45 calculates the normal-direction movement amount V for compensating for the gap amount G in the calculated normal direction sZ to the desired gap amount Go. The gap compensation unit 36 causes the machining nozzle 72 and the workpiece 82 to relatively move in the normal direction sZ of the current machining surface Sc by the calculated normal-direction movement amount V. Thereby, similarly to the case of the first embodiment, the gap amount G is compensated to the desired gap amount Go, and the laser radiation position P is also compensated to the desired radiation position Po.

According to the present embodiment, the current machining surface changing unit 43 selects one of the plurality of machining surfaces S as the current machining surface Sc based on the rotation angle θ of the workpiece 82. The normal calculation unit 44 calculates the normal direction sZ of the current machining surface Sc. The gap compensation unit 36 causes the machining nozzle 72 and the workpiece 82 to relatively move in the normal direction sZ of the current machining surface Sc. Therefore, even in a case where the workpiece 82 has a plurality of machining surfaces S, such as a case where the workpiece 82 is a square pipe, it is possible to respond thereto without changing settings for the machining surface S.

### Other Embodiments

The embodiments described above can be changed, for example, as follows. The numerical control device 50 may be configured with a device dedicated to numerical control instead of being configured mainly with the computer Cp and the numerical control program 50p.

### EXPLANATION OF REFERENCE NUMERALS

44 normal calculation unit
45 movement amount calculation unit
50 numerical control device
50p numerical control program
72 machining nozzle
82 workpiece
90 machine tool
Cp computer
G gap amount
Go desired gap amount
S machining surface
sZ normal direction
sZo reference normal direction
θ rotation angle of workpiece

1. A numerical control device for controlling a machine tool, the machine tool performing relative movement of a machining nozzle and a workpiece, and radiating a laser beam toward a machining surface of the workpiece from the machining nozzle, thereby performing laser machining on the machining surface, the numerical control device comprising:
a gap amount acquisition unit acquiring a gap amount as a shortest distance from the machining nozzle to the machining surface;
a normal calculation unit calculating a normal direction of the machining surface;
a movement amount calculation unit calculating a normal-direction movement amount as a movement amount for setting the gap amount to a desired gap amount by causing the machining nozzle and the workpiece to relatively move in the calculated normal direction; and
a gap compensation unit compensating for the gap amount to the desired gap amount by causing the machining nozzle and the workpiece to relatively move in the normal direction based on the calculated normal-direction movement amount.

2. The numerical control device according to claim 1, wherein
the numerical control device controls the machine tool based on a machining program; and
the normal calculation unit calculates the normal direction based on a reference normal direction as the normal direction at a time when the workpiece is in a predetermined reference state, and a rotation angle from the reference state of the workpiece based on the machining program.

3. The numerical control device according to claim 1, wherein
the machining surface of the workpiece comprises a plurality of machining surfaces;
the numerical control device comprises a current machining surface changing unit, the current machining surface changing unit selecting one of the plurality of machining surfaces as a current machining surface based on the rotation angle of the workpiece;
the normal calculation unit calculates a normal direction of the current machining surface; and
the gap compensation unit causes the machining nozzle and the workpiece to relatively move in the normal direction of the current machining surface.

4. A non-transitory computer-readable storage medium storing a numerical control program for causing a computer to function as:
a numerical control device for controlling a machine tool, the machine tool performing relative movement of a machining nozzle and a workpiece, and radiating a laser beam toward a machining surface of the workpiece from the machining nozzle, thereby performing laser machining on the machining surface,
the numerical control program further causing the computer to function as:
a gap amount acquisition unit acquiring a gap amount as a shortest distance from the machining nozzle to the machining surface;
a normal calculation unit calculating a normal direction of the machining surface;
a movement amount calculation unit calculating a normal-direction movement amount as a movement amount for setting the gap amount to a desired gap amount by causing the machining nozzle and the workpiece to relatively move in the calculated normal direction; and
a gap compensation unit compensating for the gap amount to the desired gap amount by causing the machining nozzle and the workpiece to relatively move in the normal direction based on the calculated normal-direction movement amount.
